(19) United States
(12) Patent Application Publication
(10) Pub. No.: US 2014/0344960 A1
(43) Pub. Date: Nov. 20, 2014

(54) SELECTIVE CONTROL OF ON-CHIP DEBUG CIRCUITRY OF EMBEDDED PROCESSORS

(71) Applicant: LSI Corporation, San Jose, CA (US)

(72) Inventor: Lyle Adams, San Jose, CA (US)

(73) Assignee: LSI Corporation, San Jose, CA (US)

(21) Appl. No.: 13/899,795

(22) Filed: May 22, 2013

Related U.S. Application Data
(60) Provisional application No. 61/824,575, filed on May 17, 2013.

(51) Int. Cl. G06F 21/86

(52) U.S. Cl. CPC G06F 21/86
USPC 726/34

(57) ABSTRACT

An apparatus includes a first circuit portion, a second circuit portion, and a control circuit. The first circuit portion may include a first debug circuit. Access to the first debug circuit may be controlled by a first control signal. The second circuit portion may include a second debug circuit. Access to the second debug circuit may be controlled by a second control signal. The second circuit portion is generally controlled according to a secure firmware image. The control circuit may be configured to selectively disable access to the first debug circuit and access to the second debug circuit by generating the first and second control signals. When access to the second debug circuit is disabled, access to the second debug circuit can only be re-enabled by overwriting at least a portion of the secure firmware image.

This application relates to U.S. Provisional Application No. 61/824,575, filed May 17, 2013, which is hereby incorporated by reference in its entirety.

### FIELD OF THE INVENTION

The invention relates to integrated circuit testing generally and, more particularly, to a method and/or apparatus for implementing selective control of on-chip debug circuitry of embedded processors.

### BACKGROUND

Chips with embedded processors need some facility to debug the operation of the code (firmware, for example) executing on the processor. The debug facility generally includes a method of taking control of one or more processors in order to observe and manipulate both an internal state of the processor and a state of hardware resources accessible to the processor (e.g., memory contents). The integrity of a chip with an embedded processor and the security of the data contained therein can be compromised if the debug interface is accessible to an unauthorized person (a hacker, for example). A number of methods for preventing unauthorized access to the debug interface are commonly used. However, common methods of preventing unauthorized access to the debug interface have compromises. The compromises include (i) an inability to gain access to the debug interface for failure analysis of field returns and (ii) a possibility that an enterprising person will be able to access an undocumented interface. It would be desirable to implement selective control of on-chip debug circuitry of embedded processors.

### SUMMARY

The invention concerns an apparatus includes a first circuit portion, a second circuit portion, and a control circuit. The first circuit portion may include a first debug circuit. Access to the first debug circuit may be controlled by a first control signal. The second circuit portion may include a second debug circuit. Access to the second debug circuit may be controlled by a second control signal. The second circuit portion is generally controlled according to a secure firmware image. The control circuit may be configured to selectively disable access to the first debug circuit and access to the second debug circuit by generating the first and second control signals. When access to the second debug circuit is disabled, access to the second debug circuit can only be re-enabled by overwriting at least a portion of the secure firmware image.

### BRIEF DESCRIPTION OF THE FIGURES

Embodiments of the invention will be apparent from the following detailed description and the appended claims and drawings in which:

FIG. 1 is a diagram illustrating an example debug interface in accordance with an embodiment of the invention;

FIG. 2 is a diagram illustrating another example debug interface in accordance with an embodiment of the invention;

FIG. 3 is a diagram illustrating an integrated circuit implementing a on-chip debug circuit in accordance with an embodiment of the invention;

FIG. 4 is a diagram illustrating a non-volatile memory system with a controller that includes an on-chip debug circuit in accordance with an embodiment of the invention;

FIG. 5 is a diagram illustrating an example production process in accordance with an embodiment of the invention; and

FIG. 6 is a diagram illustrating an example diagnostic process in accordance with an embodiment of the invention.

### DETAILED DESCRIPTION OF EMBODIMENTS

Embodiments of the invention include providing selective control of on-chip debug circuitry of embedded processors that may (i) selectively secure a debug interface, (ii) provide selective control of on-chip debug JTAG in-circuit emulation (OCD JTAG ICE), (iii) in a secure environment, provide the ability to enable the debug interface from power-up until execution of a secure firmware, (iv) in a potentially unsecure environment, provide the ability to disable the debug interface until the execution of secure firmware code, (v) provide the ability of secure firmware to enable access to some or all debug interfaces of one or more processors, (vi) provide the ability of trusted (but not secure) firmware code to enable access to some debug interfaces of less than all of the processors on a chip, (vii) provide the ability of secure firmware code to prevent trusted firmware from enabling access to the debug interface of any processor, (viii) eliminate any permanent disabling of the debug interface that would prevent failure analysis of field returns, (ix) eliminate the availability of a debug interface that can be used to gain unauthorized control of any embedded processor, and/or (x) eliminate interaction with an external security authentication device (e.g., a login ID or security key authentication).

Embodiments of the invention allow a chip supplier to develop proprietary product firmware and then secure the proprietary firmware before shipping chips to a customer. The customer may then develop unique firmware on an unsecured portion (e.g., processor, etc.) of the chip with access to the secure portion of the chip only through predefined communication interfaces. Once development of the firmware of the customer is complete, the customer can ship devices with all debug interfaces secured. The use of the term secure in connection with a particular item (e.g., firmware) refers to the chip supplier being enabled to maintain tight control over the particular item.

When a field failure occurs, the defective device is returned to the customer, who can diagnose the failure by enabling the debug interface of the “customer” portion of the device. If the customer is unable to diagnose the problem, the device may be sent to the chip supplier, who can enable the debug interface of all portions of the device for further failure analysis.

Embodiments of the invention may be applied to any chip that contains multiple portions (e.g., more than one processor, more than one debug interface, etc.), where at least one portion is secure (e.g., firmware associated with the secure portion is tightly controlled by the chip provider). Other portions (e.g., at least one processor, circuit, interface, etc.) may be unsecure (e.g., the firmware is not tightly controlled by the chip provider). In various embodiments, the secure portions (e.g., processors, etc.) are “firewalled” from the unsecure portions (e.g., processors, etc.). For example, the unsecure firmware cannot observe or alter the state of the secure processors or secure firmware code associated with the secure processors except through predefined communication protocols defined by the chip supplier. The chip supplier and chip customer ensure that the firmware code and processor execution are protected (secured) on any post-production device prior to delivery to end-users, and that both the chip supplier and customer can later enable the debug interfaces of the respective portions (e.g., processors, etc.) of the chip. In various embodiments, the customer can enable debug of the unsecure processor(s) without any visibility into the secured portion of the chip. The chip supplier can enable debug of all processors through the secure firmware. In various embodiments, the chip supplier can enable debug of all processors by overwriting at least a portion of the secure firmware image with a diagnostic firmware image.

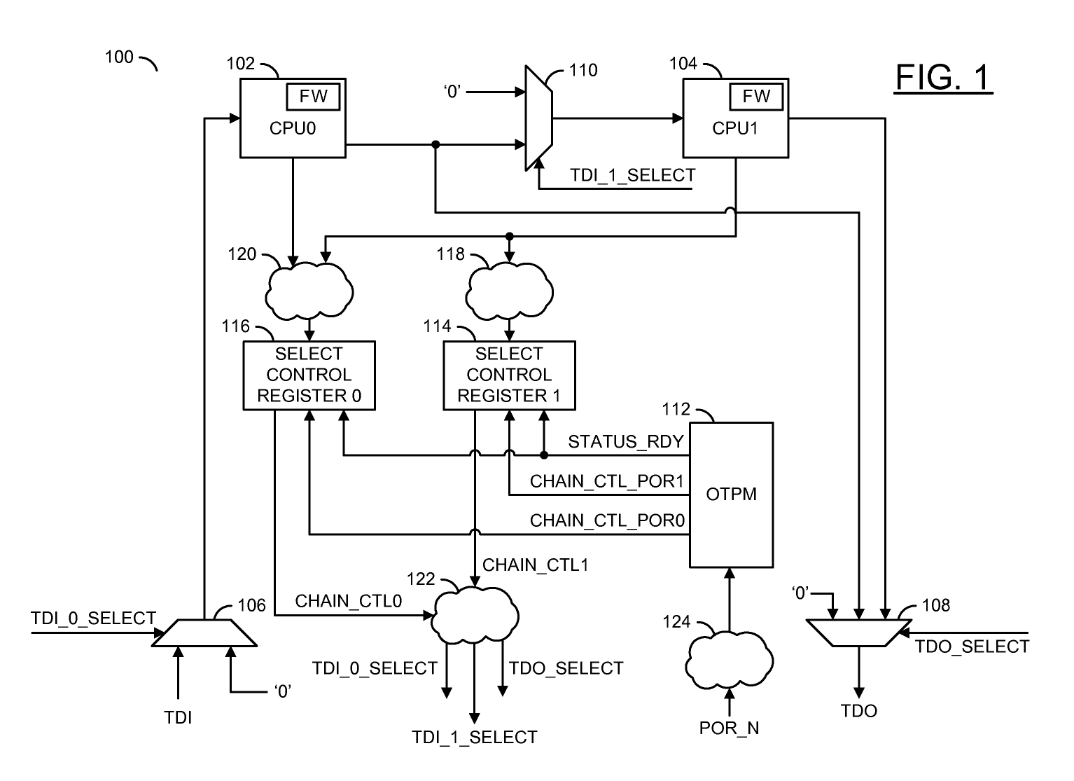

Referring to FIG. 1, a block diagram of a circuit 100 is shown illustrating a number of processors interconnected with an example debug interface in accordance with an embodiment of the invention. In some embodiments, the circuit 100 comprises a block (or circuit) 102, a block (or circuit) 104, a block (or circuit) 106, a block (or circuit) 108, a block (or circuit) 110, a block (or circuit) 112, a block (or circuit) 114, a block (or circuit) 116, a block (or circuit) 118, a block (or circuit) 120, a block (or circuit) 122, and a block (or circuit) 124. The blocks 102 and 104 may be implemented as one or more processors (e.g., a central processing unit (CPU), a digital signal processor (DSP), a non-volatile memory (NVM) control processor, etc.). In various embodiments, the block 102 may implement an unsecure processor and the block 104 may implement a secure processor. Each of the processor instances in the blocks 102 and 104 may include debug interfaces (e.g., a debug chain, a JTAG scan chain, etc.). In various embodiments, the debug interfaces are daisy chained through the blocks 102 and 104.

In various embodiments, the blocks 106 and 108 implement external debug interfaces. For example, in some embodiments, the blocks 106 and 108 may be part of a test access port (TAP) of an integrated circuit containing the debug circuit 100. The block 106 has a first input that receives a signal (e.g., TDI), a second input that receives a “null” input (e.g., a logic 0), a control input that receives a control signal (e.g., TDI_{—}0_SELECT), and an output that is operatively coupled to an input of the debug interface of the block 102. The block 108 has a first input that is operatively coupled to an output of the debug interface of the block 102, a second input that is operatively coupled to an output of the debug interface of the block 104, a third input that receives a “null” input (e.g., a logic 0), a control input that receives a control signal (e.g., TDO_SELECT), and an output that presents a signal (e.g., TDO). The signal TDI is generally used to communicate a test data input (e.g., test vectors) to the debug interface 100. The signal TDO is used to communicate a test data output of the debug interface 100.

The signal TDI generally communicates the test data input from an external debug interface. The signal TDO generally communicates the test data output to the external debug interface. In some embodiments, the external debug interface is implemented as a JTAG test access port (TAP). Other signals associated with the JTAG test access port may be implemented also. The other JTAG signals have been omitted for clarity, but would be apparent to those having ordinary skill in the art. In some embodiments, the blocks 106 and 108 include selectors (e.g., multiplexers) configured to select between enabling signals to pass through the debug chain and disabling such passage. The disruption of the debug path provides a logical method for disabling the debug interface.

In various embodiments, the block 110 may implement a selector between the block 102 and the block 104. The block 110 may be configured to allow selective enabling of the debug interface 100 to the block 102 only (e.g., partial debug access) or to both the block 102 and the block 104 (e.g., full debug access). The block 110 has a first input that is operatively coupled to the output of the debug interface of the block 102, a second input that receives a “null” input (e.g., a logic 0), a control input that receives a control signal (e.g., TDI_{—}1_SELECT), and an output that is operatively coupled to an input of the debug interface of the block 104.

In various embodiments, the block 112 implements a one-time programmable memory (OTPM) circuit (e.g., fuses, anti-fuses, etc.) that is programmed to generate one or more signals indicative of a security level of the environment. For example, in various embodiments, the block 112 may implement a number of signals (e.g., bits) where a state of each signal is determined by a state (e.g., intact or blown) of a respective fuse. In some embodiments, the block 112 implements a number of signals (e.g., bits), where each signal is based on a state of a number (e.g., 3) of fuse or anti-fuse elements combined with a majority function. The majority function corrects for single-bit errors in the fuse memory array. The majority function may be implemented in hardware using gates (e.g., AND, OR, NAND) or multiplexers.

In the example shown in FIG. 1, a two-bits wide signal may be generated where a value of zero (e.g., “00”) in both bits may be used to indicate that the environment is completely secure. A value of one (e.g., “01”) may be used to indicate that the block 102 is unsecure and the block 104 is secure. Other values (e.g., “10” and “11”) may indicate that neither the block 102 nor the block 104 is secure. However, other widths, numbers of signals, and/or levels may be implemented accordingly to meet the design criteria of a particular implementation. The settings of the elements in the block 112 generally allows (i) the debug interface to both of the blocks 102 and 104 to be enabled when the chip is virgin (e.g., during initial product development), (ii) the debug interface for the block 104 to be secured when firmware is being debugged on the block 102 (e.g., during customer product development), and (iii) the debug interfaces for both the block 102 and the block 104 to be secured (e.g., during use in an end user environment).

In various embodiments, the blocks 114 and 116 are implemented as control registers. In some embodiments, the blocks 114 and 116 are implemented using flip-flops. The programmed settings of the block 112 provide respective reset values for the blocks 114 and 116. In some embodiments, the reset values are applied whenever a signal (e.g., STATUS_RDY) is asserted. The signal STATUS_RDY is generally asserted at chip reset, ensuring that the debug interfaces are disabled any time the chip is reset, including at chip power-up.

The blocks 118 and 120 generally implement logic that allows for post-reset control of the security level of the circuit 100. In some embodiments, the block 104 is coupled (i) to the block 114 by the block 118 and (ii) to the block 116 by the block 120. The block 102 is coupled to the block 116 also by the block 120. The blocks 118 and 120 generally implement the appropriate logic for interfacing the blocks 102, 104, 114, and 116. The post-reset security levels can be selected by changing the values stored in the blocks 114 and 116. Security levels are achieved by limiting write access to the blocks 114 and 116. The block 114 is only writable by the block 104, which executes secure firmware (FW). Thus, the debug interface of the block 104 can be enabled at any time by the secure firmware running on the block 104. The block 116 is writable by the block 102 and the block 104. Firmware running on the block 102 can enable the debug interface of the block 102 only. Secure firmware running on the block 104 can enable the debug interfaces of both the block 102 and the block 104 by writing to both of the blocks 114 and 116 or can enable the debug interface of the block 102 alone.

The block 122 generally implements logic for generating the signals TDI_{—}0_SELECT, TDI_{—}1_SELECT, and TDO_SELECT based upon the values stored in the blocks 114 and 116. In some embodiments, the block 122 is implemented as a decoder. An example decoding function of the block 122 is illustrated in the following TABLE 1:

TABLE 1

| Se- | | | | |
|---|---|---|---|---|
| lect | | | | |
| Con- | | | | |
| trol | Select | | | |
| Reg- | Control | | | |
| ister | Regis | | | |
| 0 | ter 1 | TDO_SELECT | TDI_1_SELECT | TDI_0_SELECT |
| 0 | 0 | ENABLE | ENABLE | ENABLE |
| 0 | 1 | ENABLE | DISABLE | ENABLE |
| 1 | 0 | ENABLE | ENABLE | ENABLE |
| 1 | 1 | DISABLE | DON'T-CARE | DISABLE |

The block 124 generally implements logic for coupling the block 112 to an external power-on and/or reset interface (e.g., using a signal POR_N).

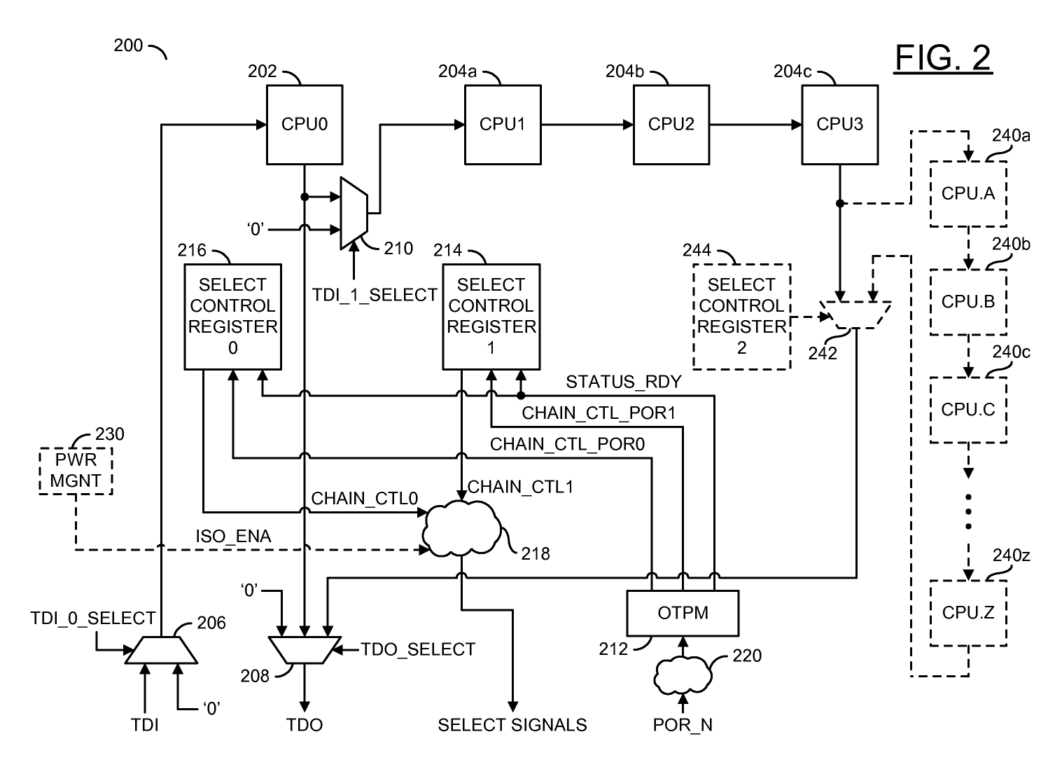

It will be apparent to one skilled in the art that the numerical encoding, including values and numbers of bits may be varied to meet the design criteria of a particular implementation. Selective security for the block 102 can also be provided by adding a selection option that routes data from the signal TDI to the block 104 while bypassing the block 102. Disabling of both the TDI and the TDO signal paths is generally not necessary. However, the inclusion of both selections can enhance security in a typical JTAG implementation by limiting injection of noise and by limiting observability. Although embodiments have been described using fuses and flip-flops (registers), it will be apparent to those skilled in the art that memory device implementations are not limited to fuses and flip-flops. Similarly, the means by which the reset values are loaded from the block 112 to the block 114 and the block 116 is not limited to a status (or fuse) readiness indicator. Although embodiments of the invention have been described using two processors and two security levels, an arbitrary number of processors can be selectively protected and an arbitrary number of security levels can be implemented (as described below in connection with FIG. 2).

Referring to FIG. 2, a block diagram of a circuit 200 is shown illustrating another example of a number of processors interconnected with an on-chip debug interface in accordance with an embodiment of the invention. In some embodiments, the circuit 200 comprises a block (or circuit) 202, a number of blocks (or circuits) 204a-204c, a block (or circuit) 206, a block (or circuit) 208, a block (or circuit) 210, a block (or circuit) 212, a block (or circuit) 214, a block (or circuit) 216, a block (or circuit) 218, and a block (or circuit) 220. The blocks 202 and 204a-204c may be implemented as one or more processors (e.g., a central processing unit (CPU), a digital signal processor (DSP), a non-volatile memory (NVM) control processor, etc.). In various embodiments, the block 202 may implement an unsecure processor and at least one of the blocks 204a-204c may implement a secure processor. Each of the processor instances in the blocks 202 and 204a-204c may include debug interfaces (e.g., a debug chain, a JTAG scan chain, etc.). In various embodiments, the debug interfaces are daisy chained through the blocks 202 and 204a-204c.

In various embodiments, the blocks 206 and 208 implement external debug interfaces. For example, in some embodiments, the blocks 206 and 208 may be part of a test access port (TAP) of an integrated circuit containing the debug circuit 200. The block 206 has a first input that receives a signal (e.g., TDI), a second input that receives a “null” input (e.g., a logic 0), a control input that receives a control signal (e.g., TDI_{—}0_SELECT), and an output that is operatively coupled to an input of the debug interface of the block 202. The block 208 has a first input that is operatively coupled to an output of the debug interface of the block 202, a second input that is operatively coupled to an output of the debug interface of the block 204c, a third input that receives a “null” input (e.g., a logic 0), a control input that receives a control signal (e.g., TDO_SELECT), and an output that presents a signal (e.g., TDO). The signal TDI is generally used to communicate a test data input (e.g., test vectors) to the debug interface 200. The signal TDO is used to communicate a test data output of the debug interface 200.

The signal TDI generally communicates the test data input from an external debug interface. The signal TDO generally communicates the test data output to the external debug interface. In some embodiments, the external debug interface is implemented as a JTAG test access port (TAP). Other signals associated with the JTAG test access port may be implemented also. The other JTAG signals have been omitted for clarity, but would be apparent to those having ordinary skill in the art. In some embodiments, the blocks 206 and 208 include selectors (e.g., multiplexers) configured to select between enabling signals to pass through the debug chain and disabling such passage. The disruption of the debug path provides a logical method for disabling the debug interface.

In various embodiments, the block 210 may implement a selector between the block 202 and the blocks 204a-204c. The block 210 may be configured to allow selective enabling of the debug interface 200 to the block 202 only (e.g., partial debug access) or to both the block 202 and the blocks 204a-204c (e.g., full debug access). The block 210 has a first input that is operatively coupled to the output of the debug interface of the block 202, a second input that receives a “null” input (e.g., a logic 0), a control input that receives a control signal (e.g., TDI_{—}1_SELECT), and an output that is operatively coupled to an input of the debug interface of the block 204a. An output of the debug interface of the block 204a is operatively coupled to an input of the debug interface of the block 204b. An output of the debug interface of the block 204b is operatively coupled to an input of the debug interface of the block 204c.

In various embodiments, the block 212 implements a one-time programmable memory (OTPM) circuit (e.g., fuses, anti-fuses, etc.) that is programmed to generate one or more signals indicative of a security level of the environment. For example, in various embodiments, the block 212 may implement a number of signals (e.g., bits) where a state of each signal is determined by a state (e.g., intact or blown) of a respective fuse. In some embodiments, the block 212 implements a number of signals (e.g., bits), where each signal is based on a state of a number (e.g., 3) of fuse or anti-fuse elements combined with a majority function. The majority function corrects for single-bit errors in the fuse memory array. The majority function may be implemented in hardware using gates (e.g., AND, OR, NAND) or multiplexers.

In the example shown in FIG. 2, a two-bits wide signal may be generated where a value of zero (e.g., “00”) in both bits may be used to indicate that the environment is completely secure. A value of one (e.g., “01”) may be used to indicate that the block 202 is unsecure and the blocks 204a-204c are secure. Other values (e.g., “10” and “11”) may indicate that neither the block 202 nor any of the blocks 204a-204c is secure. However, other widths, numbers of signals, and/or levels may be implemented accordingly to meet the design criteria of a particular implementation. The settings of the elements in the block 212 generally allows (i) the debug interface to the blocks 202 and 204a-204c to be enabled when the chip is virgin (e.g., during initial product development), (ii) the debug interfaces for the blocks 204a-204c to be secured when firmware is being debugged on the block 202 (e.g., during customer product development), and (iii) the debug interfaces for the block 202 and the blocks 204a-204c to be secured (e.g., during use in an end user environment).

In various embodiments, the blocks 214 and 216 are implemented as control registers. In some embodiments, the blocks 214 and 216 are implemented using flip-flops. The programmed settings of the block 212 provide respective reset values for the blocks 214 and 216. In some embodiments, the reset values are applied whenever a signal (e.g., STATUS_RDY) is asserted. The signal STATUS_RDY is generally asserted at chip reset, ensuring that the debug interfaces are disabled any time the chip is reset, including at chip power-up. Logic (not shown for clarity) similar to that in the blocks 118 and 120 of FIG. 1 may be implemented for interfacing the blocks 202, 204a-204c, 214, and 216. The post-reset security levels can be selected by changing the values stored in the blocks 214 and 216. Security levels are achieved by limiting write access to the blocks 214 and 216. The block 214 is only writable by at least one of the blocks 204a-204c that executes secure firmware (Fw). Thus, the debug interface of the blocks 204a-204c can be enabled at any time by the secure firmware running on the at least one of the blocks 204a-204c. The block 216 is writable by the block 202 and the at least one of the blocks 204a-204c. Firmware running on the block 202 can enable the debug interface of the block 202 only. The secure firmware running on the at least one of the blocks 204a-204c can enable the debug interfaces of both the block 202 and the blocks 204a-204c by writing to both of the blocks 214 and 216 or can enable the debug interface of the block 202 alone. The debug interfaces of the blocks 204a-204c are protected by the block 214, and at least one of the blocks 204a-204c serves as the secure processor.

In various embodiments, the logic for securing the debug interfaces is used to implement power isolation control of the debug interfaces also. For example, in some embodiments a block 230 may be implemented that provides power management. The block 230 may generate a signal (e.g., ISO_ENA) based on predetermined power management criteria. The signal ISO_ENA is then presented to the block 218 to effect power isolation control. In some embodiments, additional processors 240a-240z may be implemented. The additional processors 240a-240z are selectively included or excluded from the debug chain by the addition of a selector circuit 241 between, for example, the output of the debug interface of the block 204c and the respective input of the block 208. The selector circuit 242 may be controlled through an additional control register 244. The control register 244 may be configured and operated similarly to the block 214 and/or the block 216. As would be apparent to a person of ordinary skill in the art viewing FIG. 2, an arbitrary number of processors can be selectively protected and an arbitrary number of security levels can be implemented by scaling the number of selector circuits, the number of control registers, and the associated logic accordingly.

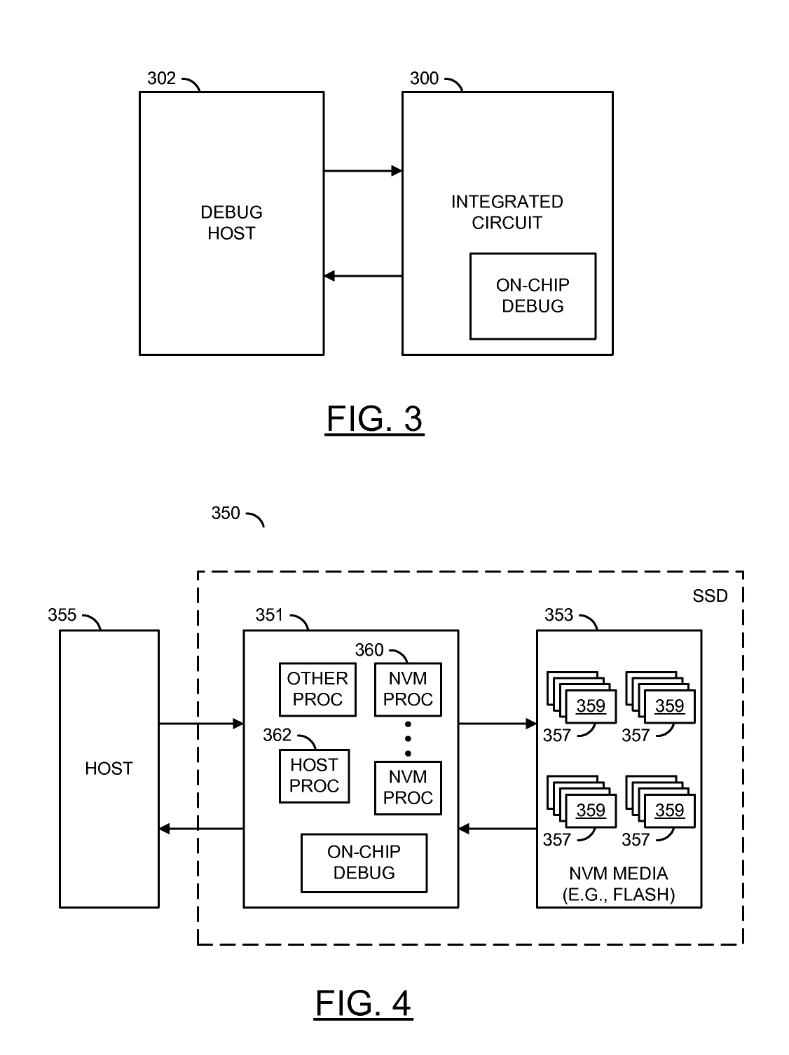

Referring to FIG. 3, a diagram is shown illustrating a integrated circuit 300 having an on-chip debug circuit in accordance with an embodiment of the invention in the context of testing. In various embodiments, the integrated circuit 300 implements multiple processors and an on-chip debug circuit in accordance with an embodiment of the invention. The integrated circuit 300 may be couple to a debug host 302 to determine a basis for a failure. The integrated circuit 300 includes a secured processor that manages proprietary operations and an unsecured processor that manages the other operations. The processors communicate via predefined interfaces. The on-chip debug circuit interfaces with both of the debug host and the processors of the integrated circuit 300 for development, debug and analysis of the integrated circuit 300.

Referring to FIG. 4, a diagram is shown illustrating a non-volatile memory system 350 in accordance with an embodiment of the invention. In various embodiments, the non-volatile memory system 350 comprises a block 351, a block 353, and a block 355. The block 351 comprises a memory controller implementing a number of processors and an on-chip debug circuit in accordance with an embodiment of the invention. The block 353 comprises a non-volatile memory (NVM) media. The block 355 comprises a host.

The controller 351 may be configured to control one or more individual non-volatile memory channels. In some embodiments, the controller 351 may implement multiple memory channel controller instances to control a plurality of non-volatile memory channels. The controller 351 has a non-volatile memory interface configured to couple the controller 351 to the non-volatile memory media 353. The non-volatile memory media 353 may comprises one or more non-volatile memory devices 357. The non-volatile memory devices 357 have, in some embodiments, one or more non-volatile memory die 359. According to a type of a particular one of the non-volatile memory devices 357, a plurality of non-volatile memory die 359 in the particular non-volatile memory device 357 are optionally and/or selectively accessible in parallel. The non-volatile memory devices 357 are generally representative of one type of storage device enabled to communicatively couple to the controller 351. However, in various embodiments, any type of storage device is usable, such as SLC (single level cell) NAND flash memory, MLC (multi-level cell) NAND flash memory, TLC (triple level cell) NAND flash memory, NOR flash memory, read-only memory (ROM), static random access memory (SRAM), dynamic random access memory (DRAM), magneto-resistive random-access memory (MRAM), ferromagnetic memory (e.g., FeRAM, F-RAM, FRAM, etc.), phase-change memory (e.g., PRAM, PCRAM, etc.), racetrack memory (or domain-wall memory (DWM)), resistive random-access memory (RRAM or ReRAM), or any other type of memory device or storage medium.

In some embodiments, the controller 351 and the non-volatile memory media 353 are implemented on separate integrated circuits. When the controller 351 and the non-volatile memory media 353 are implemented as separate integrated circuits (or devices), the non-volatile memory interface of the controller 351 is generally enabled to manage a plurality of data input/output (I/O) pins and a plurality of control I/O pins. The data I/O pins and the control I/O pins may be configured to connect the device containing the controller 351 to the external devices forming the non-volatile memory media 353. In various embodiments, the controller 351 is implemented as an embedded controller. In various embodiments, the controller 351 and the NVM media 353 implement a solid-state drive (SSD).

The controller 351 also has a command interface configured to receive commands and send responses to the host 355. In embodiments implementing a plurality of non-volatile memory devices, the controller 351 includes at least one secured NVM control processor 360 that manages the non-volatile memory devices via proprietary processes, and an unsecured host processor 362 that manages the host interface according to other processes. The NVM control processor(s) 360 and the host processor 362 communicate via predefined interfaces. The unsecured host processor 362 communicates host commands to the secured NVM control processor 362, which processes the commands according to predefined communication interfaces (or protocols). The on-chip debug circuit 200 interfaces with the debug host 355 and the host processor 362 and NVM control processor(s) 362 of the controller 351 for development, debug and analysis of the controller 351 and/or the SSD. The on-chip debug circuit 200 may interface with other processors (or circuits) of the controller 351 as well.

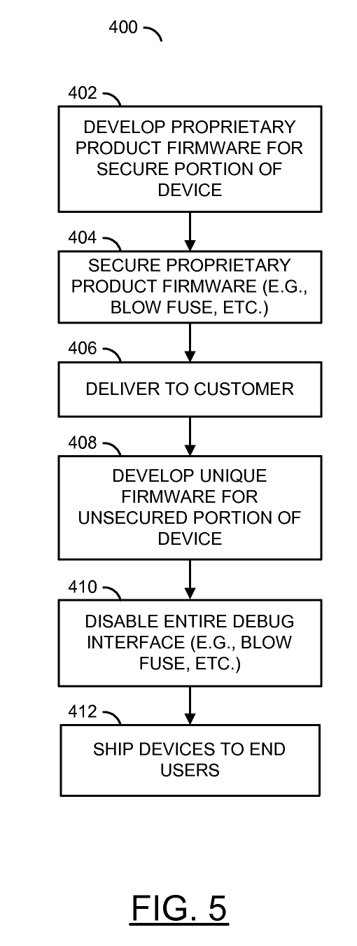

Referring to FIG. 5, a diagram is shown illustrating an example production process 400 in accordance with an embodiment of the invention. In some embodiments, the process (or method) 400 may comprise a step (or state) 402, a step (or state) 404, a step (or state) 406, a step (or state) 408, a step (or state) 410, and a step (or state) 412. In the step 402, a chip supplier may develop a proprietary product firmware for a chip (or device). In the step 404, the chip supplier may then secure (e.g., by blowing a fuse) the proprietary firmware before shipping the chip to customers. In the step 406, the chip supplier may deliver the secured chips (or devices) to the customers. In the step 408, the customers may then develop unique firmware on an unsecured portion (e.g., processor, etc.) of the chip with access to the secure portion of the chip being accomplished only through predefined communication interfaces. In the step 410, once development of the unique firmware of the customer is complete, the customer can disable the remaining debug interface(s), for example, by blowing another fuse. In the step 412, the customer may ship devices with all debug interfaces secured to end users.

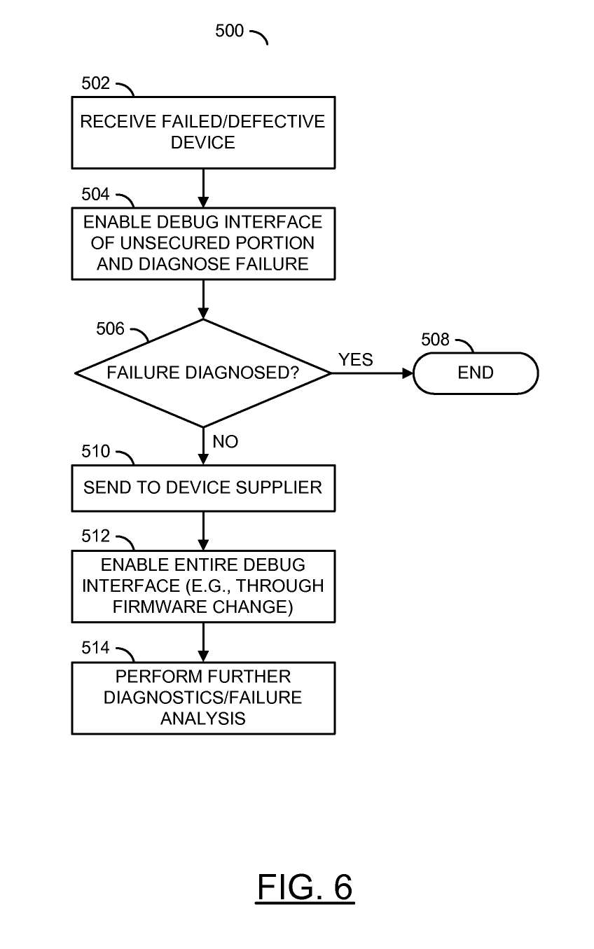

Referring to FIG. 6, a diagram is shown illustrating an example diagnostic process 500 in accordance with an embodiment of the invention. In some embodiments, the process (or method) 500 may comprise a step (or state) 502, a step (or state) 504, a step (or state) 506, a step (or state) 508, a step (or state) 510, a step (or state) 512, and a step (or state) 514. In the step 502, when a field failure occurs, the defective device may be returned to the customer. In the step 504, the customer may enable the debug interface of the “customer” (or unsecured) portion of the device and attempt to diagnose the failure. In the step 506, if the customer is able to diagnose the failure the process 500 moves to the step 508 and terminates. If the customer is unable to diagnose the problem, the process may move to the step 510. In the step 510, the customer may send the device to the chip supplier. In the step 512, the chip supplier may enable the debug interface of all portions of the device for further failure analysis. For example, in some embodiments, the chip supplier replaces at least a portion of the secure firmware image in the device with a diagnostic firmware image. In the step 513, the chip supplier may perform the additional failure analysis. By returning the defective device to the customer or chip supplier, issues involved with field troubleshooting (e.g., need for some type of field authentication) are avoided.

In various embodiments, the firmware run by a chip is automatically authenticated (e.g., by ROM boot operations) before the firmware is executed by the chip. The authentication is part of a normal boot operation and independent of any debug interface. In the factory environment, some or all of the production (secure) firmware may be replaced with a diagnostic firmware image. The diagnostic firmware image is then loaded and executed using the normal boot process. Thus, the process is not dependent upon an external authentication such as an authentication key. In the debugging process, internal states can be probed that are not normally captured by production firmware. Diagnostic tests can also be executed that would not be available in a production setting. Detected failures are generally not repaired in the defective device (e.g., a solid-state drive), but several other steps may be taken. In one example, fixes may be added to the next production release of the firmware, an errata may be issued for a defect that will not be repaired, the silicon manufacturing process data may be examined to determine if there was a detrimental change in the manufacturing process, statistical analysis may be performed to determine if the failure is within the expected range of test escapes, and/or invasive testing may be performed to determine if the part has a manufacturing flaw. In another example, the purported defective chips may be sent back to the customer for further debug—particularly if the defect is suspected to be a circuit board defect, a defect in the drive manufacturing process, or some defect other than in the chips.

After the debug process is completed, the information obtained may be used (i) to eliminate or avoid defects in devices (e.g., drives) that are subsequently manufactured, (ii) to inform customers of a defect that cannot be corrected, and/or (iii) to inform customers of a defect that will be fixed in future chip and/or firmware releases but will be present in previously manufactured devices. In the worst cases (very rare), the information gleaned during the debug process may be used to determine whether an end-customer recall event is warranted.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The functions performed by the diagrams of FIGS. 5 and 6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to embodiments thereof, it will be understood by those skilled in the art that various changes in form and details may be made without departing from the scope of the invention.

1. An apparatus comprising:
a first circuit portion comprising a first debug circuit, wherein access to said first debug circuit is controlled by a first control signal;
a second circuit portion comprising a second debug circuit, wherein access to said second debug circuit is controlled by a second control signal, said second circuit portion being controlled according to a secure firmware image;
a control circuit configured to selectively disable access to said first debug circuit and access to said second debug circuit by generating said first and second control signals, wherein when access to said second debug circuit is disabled, access to said second debug circuit can only be re-enabled by overwriting at least a portion of said secure firmware image.

2. The apparatus according to claim 1, wherein said first circuit portion comprises one or more unsecure processors and said second circuit portion comprises one or more secure processors.

3. The apparatus according to claim 1, wherein said first and second debug circuits comprise one or more debug chains.

4. The apparatus according to claim 1, wherein said first and second debug circuits provide on-chip debug in-circuit emulation.

5. The apparatus according to claim 1, wherein said control circuit comprises a number of one-time programmable elements.

6. The apparatus according to claim 5, wherein said one-time programmable elements comprise fuse or anti-fuse elements.

7. The apparatus according to claim 5, wherein said control circuit further comprises a number of registers, each configured to store a value according to a state of said number of one-time programmable elements.

8. The apparatus according to claim 7, wherein said control circuit further comprises logic configured to generate said first and second control signals according to the values stored in said registers.

9. The apparatus according to claim 1, wherein:
said first circuit portion comprises a first multiplexer configured to gate access to said first debug circuit in response to said first control signal; and
said second circuit portion comprises a second multiplexer configured to gate access to said second debug circuit in response to said second control signal.

10. The apparatus according to claim 1, wherein access to said second debug circuit is re-enabled by overwriting said secure firmware image with a self-authenticating diagnostic firmware image.

11. The apparatus according to claim 1, wherein said apparatus is first circuit portion, said second circuit portion, and said control circuit are fabricated in an integrated circuit.

12. The apparatus according to claim 1, wherein said apparatus is a non-volatile memory controller.

13. The apparatus according to claim 1, wherein said apparatus is part of a solid-state drive.

14. A method of selective control of on-chip debug circuitry comprising:
controlling access to a first debug circuit of a first portion of an integrated circuit in response to a first control signal;
controlling access to a second debug circuit of a second portion of said integrated circuit in response to a second control signal, wherein said second portion of said integrated circuit is controlled according to a secure firmware image;
generating said first and second control signals to selectively disable access to said first and second debug circuits, wherein when access to said second debug circuit is disabled, access to said second debug circuit can only be re-enabled by overwriting at least a portion of said secure firmware image.

15. The method according to claim 14, wherein:
said first circuit portion comprises one or more unsecure processors;
said second circuit portion comprises one or more secure processors; and
said first and second debug circuits comprise one or more debug chains.
